(19) United States
(12) Patent Application Publication
(10) Pub. No.: US 2020/0125244 A1
(43) Pub. Date: Apr. 23, 2020

(54) CONTEXT-BASED GRAPHICAL VIEW NAVIGATION GUIDANCE SYSTEM

(71) Applicant: David Y. Feinstein, Bellaire, TX (US)

(72) Inventor: David Y. Feinstein, Bellaire, TX (US)

(73) Assignee: INNOVENTIONS, Inc., Houston, TX (US)

(21) Appl. No.: 16/399,908

(22) Filed: Apr. 30, 2019

Related U.S. Application Data
(63) Continuation-in-part of application No. 15/000,014, filed on Jan. 18, 2016, now Pat. No. 10,296,193.
Application No. 15/000,014 is a continuation of application No. 14/169,539, filed on Jan. 31, 2014, now Pat. No. 9,424,810.
Application No. 14/169,539 is a division of application No. 12/959,367, filed on Dec. 3, 2010, now Pat. No. 8,675,019.
(60) Provisional application No. 61/266,175, filed on Dec. 3, 2009.
(60) Provisional application No. 62/818,646, filed on Mar. 14, 2019.

(51) Int. Cl. G06F 3/0484; G06T 11/60; G06T 11/00; G06F 3/0488; G06F 3/0486; G09G 5/377; G09G 5/02; G06F 3/0485; G06F 3/0481

(52) U.S. Cl. CPC G06F 3/04847; G06T 11/60; G06T 11/001; G06F 3/04883; G06F 3/0486; G06F 3/04845; G09G 2320/0666; G09G 5/026; G06F 3/0485; G06F 3/04815; G06F 3/04855; G09G 2340/12; G09G 2320/0686; G09G 5/377

(57) ABSTRACT

System and methods for context-based view navigation guidance system for large virtual displays, 360° media, and three-dimensional virtual models. Guidance map comprises graphical objects that represent the virtual display and the screen view. The guidance map may be placed in a heads-up display layer within a relatively small user defined area of the physical display to provide a context-based indication of the current position of the screen view and the magnification level, with minimal obstruction of the contents information. Colors selections for the guidance map graphical objects may be automatically determined based on the background colors in the main display layer beneath the map. The position of the guidance map may be dynamically changed during the view navigation to minimize obstruction of the contents information.

### CROSS-REFERENCE TO RELATED APPLICATIONS

This application is a continuation-in-part of U.S. application Ser. No. 15/000,014 filed Jan. 18, 2016, which is a continuation of U.S. application Ser. No. 14/169,539 filed Jan. 31, 2014, now U.S. Pat. No. 9,424,810, which is a divisional of U.S. application Ser. No. 12/959,367 filed Dec. 3, 2010, now U.S. Pat. No. 8,675,019, which claims the benefit of provisional patent application Ser. No. 61/266,175, filed Dec. 3, 2009. This application claims the benefit of provisional patent application Ser. No. 62/818,646 filed Mar. 14, 2019. All of these applications are incorporated by reference herein in entirety.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

### 1. Field of the Invention

The present invention relates, in general, to the field of view navigation of computing and communication devices utilizing an information display, and more particularly, to a context-based graphical view navigation guidance system that assists the user in guiding the view navigation of the information display.

### 2. Description of the Related Art

Hand held devices with a small physical display often must show a virtual stored or computed contents display that is larger than the screen view of the physical display. Only a portion of the virtual display can be shown at any given time within the screen view, thus requiring an interactive process of view navigation that determines which particular portion of the virtual display is shown. Similarly, desk-top display monitors also need to deal with a large virtual contents display that show only a part of the contents on the screen at any given time.

This view navigation process must allow the user to scroll the entire virtual display. Various methods have been used to control view navigation, including keyboards, joysticks, touch screens, voice commands, and rotational and movement sensors. Since the user can see only the screen view, there is a need for an efficient guidance system to indicate to the user what portion of the virtual display is currently shown and which direction should the user scroll the screen view.

U.S. Pat. Nos. 5,510,808, 6,008,807 and 6,014,140, together with the references stated in these patents, describe the well known prior art scrollbar method for guiding view navigation. In this method, horizontal and vertical scrollbars, typically placed on the bottom and right boundaries of the display, indicate the relative position and size of the screen view to the virtual display. As the user scrolls the display, the scrollbars change to reflect the new position of the screen view. In applications where the virtual display size changes dynamically, the length of each scrollbar slider changes to reflect the relative width and height of the screen view compared to the virtual display.

Scrollbars view navigation guidance generally works well with large stationary desk-top displays. However, it exhibits major disadvantages for smaller displays used in hand held devices. One disadvantage is that the user must look at both scrollbars in order to determine the screen view position within the virtual display. It is even more difficult for the user to determine the relative size of the screen view compared to the size of the virtual display since the user must assimilate the width information separately from the horizontal bar and the height information separately from the vertical bar.

Another disadvantage is that the scrollbars consume some valuable screen view spaces. For example, in a typical smart phone with a 320×480=153600 pixels screen view, the scrollbars may reduce the usable screen to 300×460=138000 pixels, that is a reduction by almost 10%.

Scrollbars are also not useful for modern 360° panorama images and immersive videos contents, as rotation of the scenery beyond 360° repeats the same initial screen. When using a mobile device to view a 360° panorama image, the user has the spatial feel of which direction she points the screen. On desk-top displays, the user typically rotates the image with the mouse or keyboard and there is a total lack of the directional orientation.

U.S. Pat. No. 7,467,356 describes a graphical user interface that includes a mini-map area that is placed on the display near the main information pan. The mini-map conveys a lot of information and therefore it must be placed in a separate and dedicated area that cannot be used for contents display. This poses a major disadvantage for small displays where every pixel is important and cannot be assigned exclusively for view guidance.

Originally, heads-up display (HUD) was developed for use in fighter airplanes where various data is projected on the front window so that the pilot can view both the projected data and the battlefield scene simultaneously. In the context of video games and virtual displays that use a stand-alone physical display, a heads-up display (HUD) is a partially transparent graphical layer containing important information placed on top of all the other graphical layers of the application information contents. All graphical layers are combined in vertical order for rendering in the physical display, giving the HUD layer a perceived affect of being on top. The HUD layer is assigned a transparency parameter Alpha which is varied from 0 (invisible) to 1 (fully opaque).

U.S. Pat. No. 7,054,878 illustrates the use of heads-up display on a desktop computer. U.S. Pat. No. 7,115,031 illustrates combination of local game view and common game view with multiple players, where the common game view is transparently rendered as HUD on top of the local game view. An article titled “Multimedia presentation for computer games and Web 3.0”, by Ole-Ivar Holthe in IEEE MultiMedia, December 2009, discusses modern use of in-game head-up displays. Geelix HUD, an in-game Heads-Up Display for sharing game experiences with other users, is available from www.geeix.com. Version 4.0.6, first seen on internet Sep. 20, 2007. Use of HUD in gaming is described in Wikipedia at http://en.wikipedia.org/wiki/HUD_(video_gaming), while the concept of mini-map is shown in http://en.wikipedia.org/wiki/Mini-map.

Use of HUD display heretofore known suffer from a number of disadvantages. First, the HUD layer optically obstructs important contents data, which is a bigger problem in the small display of hand-held devices. Secondly, the HUD layer tends to grab the user's attention, thus becoming a perceptual distraction to the user.

### BRIEF SUMMARY OF THE INVENTION

With these problems in mind, the present invention seeks to improve the guidance provided to the user while navigating the virtual display. It uses a simplified context-based graphical guidance map that is shown via HUD in a small predefined area of the screen view. In its minimal implementation, this guidance map is substantially limited to exhibit just two frame shapes representing the screen view inside the contents view. More context-based graphical information can be shown within the two frames to further assist the user's navigation process. It improves the HUD technique with emphasis on clarity and minimal optical and perceptual obstruction of data contents.

Since the guidance map comprises only two frames with limited (or reduced) contents, it is mostly transparent, thus allowing the user to see the content layer that lies under it. The guidance map should also be colored in a way that will make it visible over the background, but not distracting. Due to the scrolling of the virtual display and changing contents information under the guidance map, the present invention uses dynamical color selection to paint the map's shapes and contents.

It is much easier for the user to determine where to steer the screen view in relation to the virtual display when looking only at a relatively small and very simple map within the screen view area as opposed to monitoring two scrollbars that are placed along the boundaries of the screen view. The map immediately conveys both relative position and relative size of the screen view compared to the virtual display. These benefits are useful for both small hand held displays as well as for larger stationary desktop displays.

Another embodiment of the present invention seeks to improve the user experience when navigating 360° panorama images and 360° video contents by providing a context-based graphical map. The 360° panorama contents are dynamically divided onto a front section and a back section, each section with the corresponding 180° of the contents. The user can clearly see where the current screen view is taken from the entire contents.

Another embodiment of the present invention seeks to improve the user experience when viewing three-dimensional objects by providing a context-based graphical map.

In another embodiment of the present invention in systems that employ a touch screen interface, the guidance map is placed on the screen view in a position that may be changed by the user during the view navigation. These position changes detected along predefined paths during the view navigation are used to send control signals to the system to change the navigation parameters. The present invention is very advantageous for view navigation based on rotational (tilt) and movement sensors. Such view navigation further uses various parameters that control the speed of navigation and its associated response to user's movements.

In yet another embodiment of the present invention, the predefined guidance map area may include functional switches that respond to tapping by the user.

These and other objects, advantages, and features shall hereinafter appear, and for the purpose of illustrations, but not for limitation, exemplary embodiments of the present invention are described in the following detailed description and illustrated in the accompanying drawings.

### BRIEF DESCRIPTION OF THE SEVERAL VIEWS OF THE DRAWINGS

For a better understanding of the aforementioned embodiments of the invention as well as additional embodiments thereof, reference should be made to the Detailed Description of the invention, in conjunction with the following drawings. It should be understood that these drawings depict only exemplary embodiments of the present disclosure and therefore are not to be considered to be limiting its scope. In the drawings, like reference numerals designate corresponding elements, and closely related figures have the same number but different alphabetic suffixes.

FIG. 1 illustrates a sample virtual display

FIG. 2A and FIG. 2B (prior art) show the use of scrollbars for determining the position of the screen view within the virtual display of FIG. 1. FIG. 2A and FIG. 2B illustrate different screen views.

FIGS. 3A, 3B and 3C show the view navigation guidance system in some embodiments of the present invention which includes a proportional guidance map embedded in a heads-up display layered over the screen view. FIG. 3A and FIG. 3B illustrate the same screen views of FIG. 2A and FIG. 2B, respectively. FIG. 3C shows the same screen view of FIG. 3B using a context-based guidance map.

FIGS. 4A, 4B and 4C provide close-up views of the view navigation guidance map illustrating the relations between the screen view and the virtual display. FIG. 4A shows a relatively large and wide virtual display while FIG. 4B illustrates a smaller and narrower virtual display. FIG. 4C illustrates a context-based implementation of the guidance map of FIG. 4A.

FIG. 5A and FIG. 5B illustrate the implementation of the present invention for virtual displays and screen views that have different shapes. FIG. 5A depicts a circular screen and FIG. 5B shows a virtual display with irregular shape.

FIG. 6 depicts some embodiments of the present invention with a guidance map that includes more controls on the heads-up display area.

FIG. 7 illustrates the block diagram of a view navigation guidance system in some embodiments of the present invention.

FIG. 8 outlines the software flow diagram for the embodiment of the invention of FIG. 7.

FIG. 9 illustrates the color and transparency selection process for the guidance map in some embodiments of the present invention that minimizes the obstruction of the screen view while still providing a good readability.

FIG. 10 depicts a clipping of the content view rectangle in some embodiments of the present invention that further minimizes the obstruction of the screen view.

FIG. 11 shows another embodiment of the present invention with a touch sensitive display where the guidance map may be dragged by the user to change view navigation parameters on the fly.

FIG. 12 outlines the software flow diagram of the embodiment of FIG. 11.

FIG. 13 is a sample virtual display of a 360° panoramic image.

FIG. 14A and FIG. 14B illustrate directional guidance maps in some embodiments of the present invention for 360° panoramic contents.

FIG. 14C illustrates the directional guidance map with a screen view of the sample virtual display of FIG. 13

FIG. 15A illustrates the context-based guidance map of FIG. 4C with a screen view of the sample of FIG. 13.

FIG. 15B shows a partition of the guidance map of FIG. 15A.

FIG. 16A illustrates a cylindrical projection of the guidance map.

FIG. 16B shows a modified cylindrical projection of the guidance map for the screen view shown in FIGS. 14C and 15A.

FIG. 16C shows a modified spherical projection of the context-based guidance map.

FIG. 17 outlines the software flow diagram for some embodiments of the modified cylindrical projection of FIG. 16B.

FIGS. 18A, 18B and 18C illustrate different screen views from the virtual display of FIG. 13 with the cylindrical projection guidance map. FIG. 18A and FIG. 18B show screen views taken from opposite directions, and FIG. 18C illustrates a highly magnified screen view.

FIG. 19A and FIG. 19B illustrate context-based guidance map for viewing three-dimensional virtual models. FIG. 19A shows the virtual model at a low magnification while FIG. 19B shows the same virtual model at a different virtual direction and at a higher magnification.

FIG. 20 outlines the software flow diagram for rendering the three-dimensional virtual model viewer of FIG. 19A and FIG. 19B.

### DETAILED DESCRIPTION OF THE INVENTION

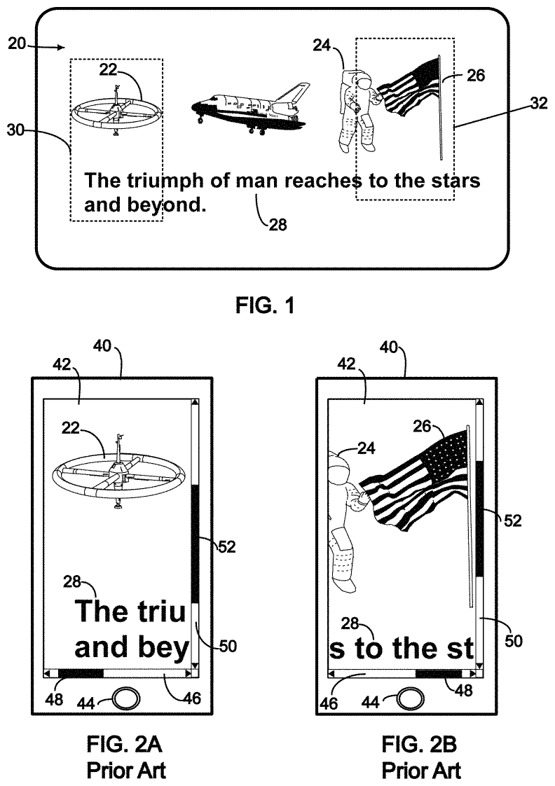

FIG. 1 illustrates a sample virtual display (also called “contents view”) 20 that can be scrolled and magnified by a screen view (physical display). The virtual display 20 is the stored or computed data contents view and may include images, text, video, drawings, data tables and any other viewable item. The sample virtual display of FIG. 1 is an image that comprises few graphical objects 22, 24, and 26, as well as a text message 28. It should be noted that the virtual display may be retrieved from a stored virtual display memory area or computed on the fly based on data streaming (e.g. from a web site or from dynamically selected data files). Two rectangular sections of the contents view, marked 30 and 32, represent two arbitrary areas of the contents view that may be scrolled by the screen view.

FIG. 2A and FIG. 2B (prior art) illustrate the use of scroll bars to guide the navigation of contents view 20 by a hand held device 40. The hand held device 40 includes a screen view 42 and one or more operational buttons 44. FIG. 2A (prior art) shows the screen view 42 of the hand-held device 40 when it has been navigated to area 30 of the virtual display 20. FIG. 2B (prior art) shows the screen view 42 when it has been navigated to area 32 of the virtual display. The screen view 42 includes a horizontal scrollbar 46 and a vertical scrollbar 50. The horizontal scrollbar 46 has a horizontal slider 48, and the vertical scrollbar has a vertical slider 52. Each slider's position along the scrollbar indicates the relative position of the screen view 42 within the virtual display 20 along the corresponding horizontal and vertical axes. The horizontal slider's width indicates the relative width of the screen view 42 to the width of the virtual display 20. Similarly, the vertical slider's length indicates the relative height of the screen view 42 to the height of the virtual display 20. It is clear that the user must consider both sliders' position and length in order to determine the screen view's size and its position in the virtual display 20. This can be very difficult and time consuming, particularly in situations where the screen view 42 is much smaller than the virtual display 20 and the navigation speed is relatively high.

It should be emphasized that the user cannot see the entire virtual display 20 within the screen view 42 unless he or she zooms out significantly. Therefore, it is desirable to have a better view navigation guidance system that allows the user to immediately determine the position and the size of the screen view 42 after a quick glance at a generally small area.

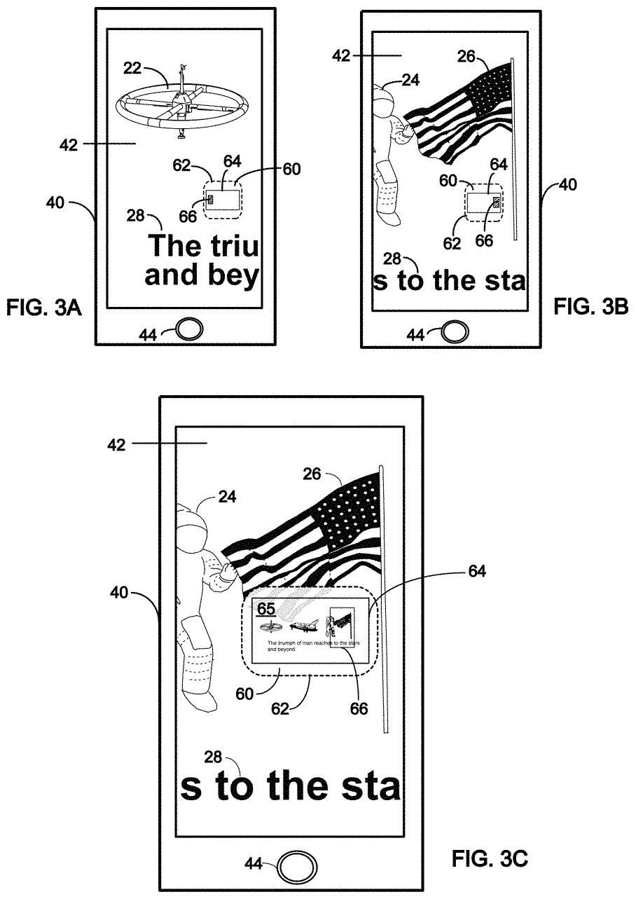

Some embodiments of the present invention that achieve this objective are illustrated in FIGS. 3A, 3B and 3C. Scrolling over the same sample virtual display 20 of FIG. 1. FIGS. 3A and 3B depict the same virtual display areas 30 and 32 of FIGS. 2A and 2B respectively. The scrollbars of FIGS. 2A and 2B are replaced with a view navigation guidance map 60, comprising a predefined small transparent view area 62 which is composed on a top layer of the screen view in a heads-up display (HUD) fashion. The well known heads-up display technique is used to display an element or a graphic view on top of a main view without obscuring the main view itself. It is generally achieved by layering the heads-up display above the main view and controlling its translucence level to be transparent. All graphical layers are combined in vertical order for rendering in the physical display, giving the HUD layer a perceived effect of being on top. The entire HUD area 62 of the navigation view guidance map 60 is set to be fully transparent. In devices that incorporate touch screen technology, the area 62 can be assigned a touch responder that is activated when touched by the user to control a predefined system function. Therefore, the boundary line of area 62 is preferably not visible, and is marked with dotted lines in all the related drawings of this patent application.

The guidance map 60 includes two rectangle shapes 64 and 66 that represent the virtual display and the screen view, respectively. While most screen views have a rectangle shape, some dynamically changing virtual displays may have other transitional shapes. Such shapes may be represented by a minimal bounding rectangle 64. The height and width of the rectangle 64 is set proportional to the height and width of the virtual display 20. The scale factor is computed so that rectangle 64 fits most of the predefined guidance system's HUD area 62. Since rectangle 64 represents the virtual display 20 within the view navigation guidance map 60, it will hereinafter be referred to as the virtual display rectangle 64. The screen view 42 is represented by rectangle 66 which has dimensions that are scaled down by the same scale factor used to render the virtual display rectangle 64. The screen view rectangle 66 is placed within the virtual display rectangle 64 in a relative position to the position of area 30 and 32 within the virtual display 20. It is therefore very easy to determine from the view navigation guidance map of FIG. 3A that the screen view 42 is area 30 of the virtual display 20. Similarly, FIG. 3B immediately conveys to the user that the screen view 42 is area 32 of the virtual display 20.

In some embodiments of the present invention, it may be desirable to include some context-based features in the guidance map 60. FIG. 3C illustrates such a guidance map where the virtual display rectangle 64 has a graphic representation 65 of the entire virtual display 20 of FIG. 1 so that the user can better determine where the screen view rectangle 66 is currently placed. This graphic representation 65 may be simply a scaled down full image of the virtual display. It may be made mono-chromatic to distinguish it from the rest of the screen view 42. Many other well known common graphic filters may be applied on the scaled down graphic representation 65 for that purpose.

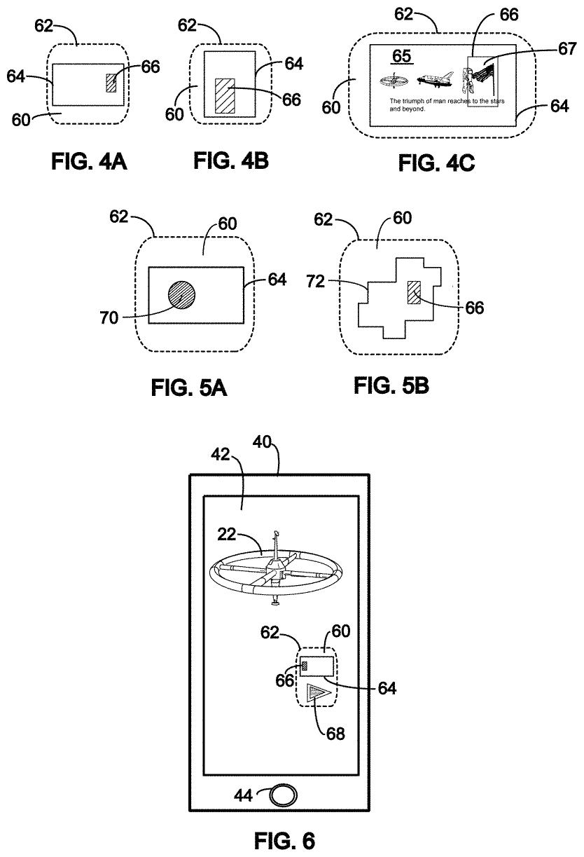

FIGS. 4A and 4B detail two instances of a minimalist embodiment of the view navigation guidance map 60 created for different sets of virtual displays and screen views. FIG. 4A shows a situation similar to FIG. 3B where the virtual display is relatively wide. FIG. 4B shows the case when the virtual display is relatively high. FIG. 4A depicts a much larger zoom-in level than FIG. 4B. The screen view rectangle 66 may be filled to emphasize it in a case like FIG. 4A where its size is much smaller than the virtual display rectangle. Since the view navigation guidance map 60 should not obscure the screen view 42, the virtual display rectangle 64 is made fully transparent, showing only the rectangle outline. Careful attention should be made in the selection of color, line width and transparency (also known as the alpha parameter in computer graphics) as it will be discussed in more detail in conjunction with FIG. 9 below.

FIG. 4C depicts a close-up view of the context-based guidance map 60 of FIG. 3C. Unlike the more minimized embodiments of the present invention shown in FIGS. 4A and 4B, the virtual display rectangle 64 includes a scaled down graphic representation 65 of the entire virtual display 20 of FIG. 1. The screen view rectangle 66 may be fully transparent of the graphic representation 65. In some embodiments, the area 67 of the screen view rectangle 66 may be emphasized when it is rendered in full color, while the rest of the graphic representation 65 of the virtual display graphic is rendered mono-chromatically.

Many other well known common graphic filters may be applied selectively to the screen view area 67 and the virtual display representation 65 to achieve a desired level of contrast and ease of use. For example, the features of the virtual display representation 65 may be minimized by various blur filters, while keeping the screen view area 67 sharp. In another example, an edge detection filter may minimize the virtual display representation area 65, while keeping the screen view area 67 intact.

The present invention can be applied to various display systems where the screen view and the virtual display are not strictly rectangular. FIG. 5A illustrates a display system with a circular shaped screen view 70. FIG. 5B illustrates a display system with a virtual display 72 of irregular shape. A virtual display with such irregular shape may be used in a mapping application, where the various portions of the map are downloaded selectively from the internet based on the scrolling directions. The irregular shape 72 appears when the user suddenly zooms out, before all the map sections are loaded.

The view navigation guidance map 60 may be extended to include more controls or indicators as shown in FIG. 6. The transparent area 62 assigned for the guidance map 60 is extended to include a touch switch 68 for use with embodiments of the present invention in devices with touch screen display. The touch switch control 68 is also created with a relatively transparent rendering to avoid obscuring the screen view. The shape and function of the touch switch 68 can be modified on the fly. It is also possible to have additional controls, making sure that they do not obscure the screen view. A single touch switch can be implemented with no additional main view obstruction by assigning a touch responder area to the entire transparent area 62. The user then activates the switch by simply tapping the guidance map 60.

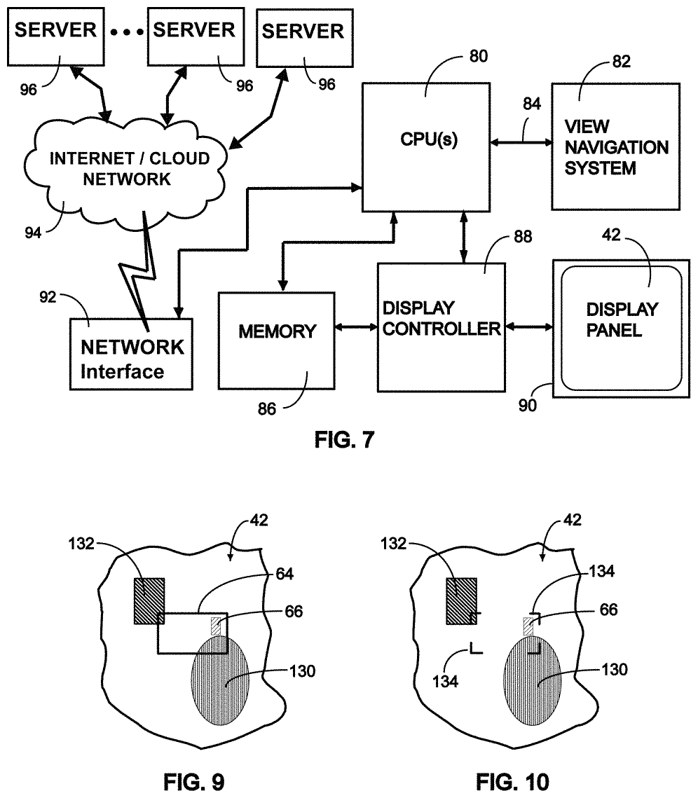

FIG. 7 discloses one embodiment of a view navigation guidance system incorporating the present invention. The processor 80 provides the processing and control means required by the system, and it comprises one or more Central Processing Units (CPU). The CPU(s) in small electronic devices are often referred to as the microprocessor or micro-controller. A view navigation system 82 interfaces with the user to perform the required view navigation. It communicates with the micro-controller 80 via the communication channel 84. The view navigation system 82 may be tilt-based, comprising a set of rotation sensors (like a tri-axis accelerometer, gyroscope, tilt sensor, or magnetic sensor). One such system is disclosed in my U.S. Pat. Nos. 6,466,198 and 6,933,923 and has been commercialized under the trade name RotoView. Other view navigation systems like keyboard, joystick, voice command, and touch screen control can be used. The processor 80 uses a memory storage device 86 for retaining the executable code (system program), and various data and display information. Multiple memory devices may be included in a typical computerized information display system, where code execution may be stored in one memory device while the virtual display contents are stored in another. Therefore, the memory storage device 86 represents all variation of memory devices that are available locally in a computerized system, including external memory like CD/DVD players. A display controller 88 activates the physical display panel 90 which provides the screen view 42 to the user. It is common for the display panel 90 to incorporate touch screen interface. The display controller 88 is controlled by the processor 80 and interfaces with the memory storage 86 for creating the screen view 42.

The contents shown on the display may reside in the local memory 86 or it can be acquired dynamically from remote servers 96 in the cloud or via the internet 94. The connection to the internet or cloud is performed via an optional network interface 92 module. It should be apparent to a person familiar in the art that many variants of the block elements comprising this diagram can be made, and that various components may be integrated together into a single VLSI chip.

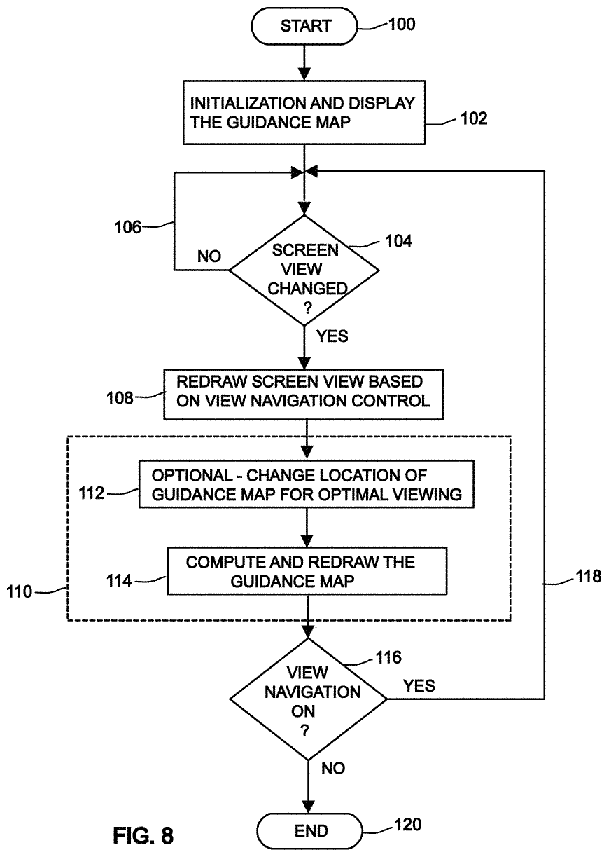

FIG. 8 illustrates the software flow diagram used to compute the view navigation guidance map of the system shown in FIG. 7. Any processor based system requires numerous software activities which are well known in the art. I only show in FIG. 8 the portion of the view navigation process that is relevant for the generation of the guidance map of the present invention. The process starts at node 100 whenever the view navigation system 82 initiates a start navigation command to the processor 80. At the initialization step 102, the processor first determines the shape and the dimensions of the virtual display frame 64 and computes the scale factor needed to reduce the frame so that it is embedded within the predefined area 62 of the guidance map 60. For example, if the map area 62 approximates a square, the larger of the width or height of the virtual display is proportionally reduced to fit the predefined area 62, and then the other dimension is reduced by the same scale factor. The same scale factor is then applied to compute the dimension of the screen view frame 66. The screen view 66 is then placed in a position within the virtual display frame 64 that reflects the actual position of screen view 42 within the virtual display 20. In some embodiments of the present invention, step 102 also computes the context-based graphic representation 65 and applies the various graphic filters as described in FIGS. 3C and 4C. Other filters may be applied in the graphic area 67 within the screen view frame 66. The initial transparency and color of the guidance map 60 is also determined in this step based on user's setup patterns, stored patterns, or the dynamic color selection algorithm described in FIG. 9 below. Step 102 draws and displays the initial configuration of the guidance map 60. Optionally the guidance map may be turned off (e.g. made invisible by setting its overall transparency to 0) when the view navigation mode ends or after a predefined delay after the navigation mode ends. In such case, step 102 should also turn the guidance map back on when the view navigation re-starts.

The navigation commands coming from the view navigation system 82 and the processor 80 will determine the required changes in the screen view in step 104. This is done via a polling of the navigation system data at a predefined rate or can equivalently be made in response to system interrupts. Changes are detected when one or more of the following events occur: the screen view contents are changed (e.g. video contents); the screen view is commanded to scroll the virtual display; the screen view magnification has changed; or the size of the virtual display has changed due to dynamic loading and release of the virtual display. If no change was detected, step 104 is repeated along the loop 106 at the navigation system predefined update rate. If changes are detected at step 104, a new screen view is computed and rendered to perform the navigation system commands in step 108. Step 108 is performed at a certain navigation update rate that needs to provide smooth response. For example, smooth view navigation has been obtained in the RotoView system when step 108 is performed at the predefined update rate of 12-20 iterations per second. Increasing this update rate above 20 iterations per second may achieve only a marginal improvement to the user experience. The view navigation update rate should not be confused with the screen display rendering rate. The navigation update rate is typically lower than the screen display rendering rate. Most display systems utilize higher screen display rendering rates to enhance the visibility, particularly when displaying video contents.

After the screen view is updated and redrawn in step 108 as part of the process of view navigation or contents changes, the guidance map 60 must also be computed and redrawn in step 110. In some embodiments of the present invention step 110 comprises two steps. The first step 112 is optional—it analyses the screen view contents and finds an optimal part of the screen view where placing the guidance map will cause minimal obstruction. Various constraints may be used to insure that position changes of the map are gradual and smooth. The second step 114 computes the new placement of the screen view frame 66 on the virtual display frame 64, and applies, if needed, the various graphic filters used to render the scaled down graphic representation 65 and screen view 67 enhancement. Finally, Step 114 redraws the guidance map 60 over the assigned HUD area 62.

In some applications like web browsing or map browsing, the scrolling of the screen view issues requests to the system to add contents data to some areas of the virtual display in the direction of scrolling, or releasing some other contents data that is no longer needed. This may be rendered in some embodiments with an irregular virtual display frame like 72 of FIG. 5B. In other applications, the contents data in the virtual display may be slowly accumulated throughout the view navigation process. Step 114 updates any changes in the shape of the virtual display and computes a new positioning of the screen view frame 66 within the virtual display frame 64. As step 114 redraws the guidance map 60, it may also include a change in coloring or transparency level based on the screen view changing local colors below the frames 66 and 64, as described in FIG. 9 below.

A counter divider or a threshold value may be used in step 110 to insure that the guidance map is updated at a lower rate than the rate at which the screen view is updated by step 108 on the display 42. For example, in one implementation I perform step 110 only once for every 5 times that the actual screen view is moved. This reduced update is not noticeable by the user since the guidance map 60 is much smaller than the screen view.

At step 116 the micro-controller 80 determines if the view navigation mode is still on. If so, steps 104, 108 and 110 are repeated via 118. If the view navigation has terminated (by lack of subsequent user scrolling commands, or due to automatic exit from view navigation mode explained in my RotoView U.S. patents) the process ends at step 120. The view navigation guidance map 60 may optionally be turned off at this point, or after some predefined time delay. As mentioned, if the guidance map is turned off, it must be reactivated by step 102 when the view navigation resumes.

It is important to insure that the guidance map 60 uses proper color, line width and transparency value selections to minimize the obstruction of the screen view while still providing good readability of the guidance system's information. These selections are performed in steps 102 and 110 of the block diagram of FIG. 8, taking into consideration the continuous changing contents of the main display layer. FIG. 9 illustrates the challenges of making these selections, using a simplified situation in a color physical display where two graphical objects 130 and 132 under the guidance map may have different colors.

Since the view area 62 of the guidance map 60 is preferably fully transparent (alpha is set to 0), only the virtual display frame 64 and the screen view frame 66 are shown on the HUD layer 62. Therefore, changes in the transparency value of the HUD layer can globally increase or decrease the overall contrast of the map's graphical representation. In addition, the line width can be changed to increase or reduce the overall visibility of the frames, particularly in monochrome displays. Depending on background objects' colors, adjusting the global transparency value of the HUD layer may not be sufficient to improve the user's experience. Therefore, smart selection of colors for the map's frames 64 and 66 and their optional internal graphic representations 65 and 67 are clearly important. This selection can be made using a global or a local approach.

The global approach selects a single primary color for painting the guidance map 60 as a function of the overall global background color of the screen view's contents in the background area directly beneath the predefined guidance map area 62. Alternatively, several additional colors may be selected to paint individual frames within the guidance map, so that their relative relation may be more easily readable by the user, while the overall guidance map is made less obstructive to the screen view 42. The overall global background color can be determined by several methods. One method sets the global background color as the average RGB primary colors values of all the pixels in the background area beneath the map 60. Another method examines the predefined background area and determines the dominant color based on color distribution weighed by some of their perceptual properties. It then assigns the dominant color as the global background color.

Once the global background color is determined, the processor selects a global painting color to paint the guidance map. There are several methods to select a painting color corresponding to a given background color. One method computes the painting color by a mathematical function that transforms the primary colors values of the global background color to achieve the desired contrast, based on the user setup preferences. Colors are generally defined by their additive primary colors values (the RGB color mode with red, green, blue) or by their subtractive primary colors value (the CMYK color model with cyan, magenta, yellow, and key black). In another method, the painting color may be selected from a predefined stored table that associates color relations based on desired contrast values. The stored table receives the background color and the desired contrast values as inputs and it outputs one or more painting colors. For example, the stored table may indicate that if the global background color is black, the painting colors should be white or yellow to achieve strong contrast, and gray or green to achieve a weak contrast.

Using the local approach, the map's frames are colored with varying colors along small sections of each frame. The frame is virtually separated into arbitrarily small sections, allowing desirable color selection to be made per each section based on the current local background in a small area under each section. A predefined local background area must be specified within a circle with predefined radius or some other common bounding polygon shape attached to each subsection. The local background color and the associated local painting color for the frames are determined per each section of the guidance map 60, using the painting selection methods discussed above. It is clear that while the local approach can achieve the best optimal coloring of the map's frame, the global method is faster.

Similar algorithms for color selections may be used to select the frame colors of the guide maps shown in FIGS. 3C and 4C, as well as determining the colors used for the graphic areas 65 and 67 within the frames. In some embodiments of the present invention that use monochromatic rendering of the scaled down graphic representation 65 of the virtual display, these color selection algorithms may be used to select the monochromatic color for each graphic area within the guidance map 60.

FIG. 10 shows that the larger virtual display rectangle 64 of FIGS. 4A, 4B, 5A and 5B may be replaced with four corner markers 134 which may be drawn in the HUD layer with more contrast than the drawing of the full rectangle 64 in the case of FIG. 9. As mentioned above, the increased contrast can be achieved with more opaque transparency, thick lines and highly contrasting color selection. The markers 134 are placed in the corners of the virtual display rectangle 64 of FIG. 9. Use of such markers in lieu of the full rectangle 64 significantly reduces the obstruction of the screen view by the guidance map.

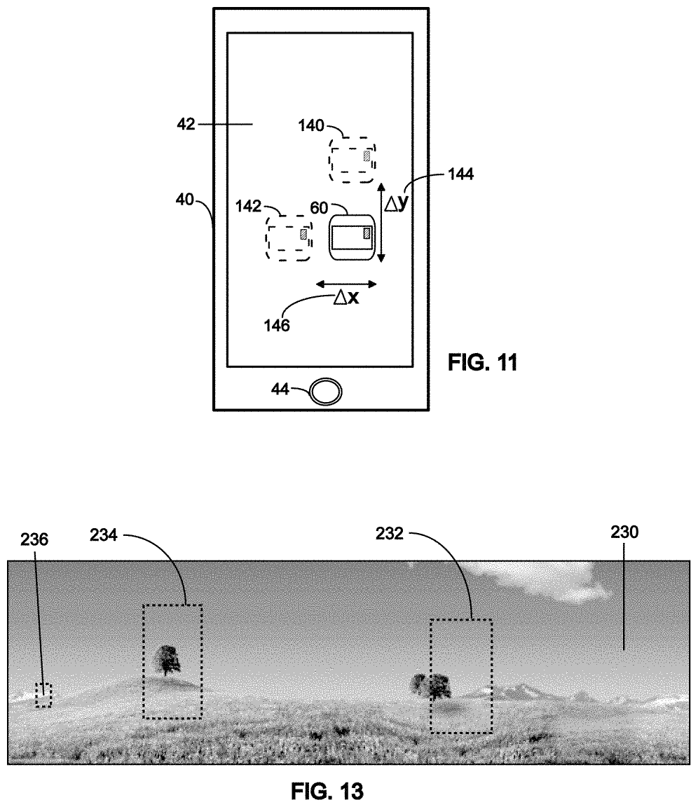

In another embodiment of the present invention, the view navigation guidance system is implemented with a physical display equipped with touch screen interface. The guidance map 60 can be dragged on the screen view 42 by the user from its predefined position and the user can also tap the map to perform a predefined control function. The interactive changes in the position of the guidance map 60 along predefined paths during view navigation can be used to change the view navigation parameters on the fly. This embodiment of the present invention is shown in FIG. 11, and it follows a similar block diagram like the one shown in FIG. 7 with touch screen capability added to the display panel 90. The guidance map may be moved vertically by amount Δy (144) to position 140, or horizontally by Δx (146) to position 142. In many cases the user may drag the guidance map with both X and Y displacements. These displacements trigger changes in the parameters of the current view navigation session in accordance with predefined paths.

It should be understood by a person skilled in the art that the control process of FIG. 11 can be applied to other embodiments of interactive processes where a graphic controller is displayed in a HUD layer over the main view of the process. Such a graphic controller may have one or more input or output user interface elements and the graphic controller may respond to touch drag commands. The user can change at least one process parameter by moving the graphic controller.

For the following discussion of the functional block diagram, we assume that this embodiment is implemented in conjunction with a tilt-based view navigation system like the aforementioned RotoView. In addition, we assume in this example that changes in the vertical direction can increase or decrease the speed of navigation, while changes in the horizontal direction select different navigation system profiles (e.g. different response graphs).

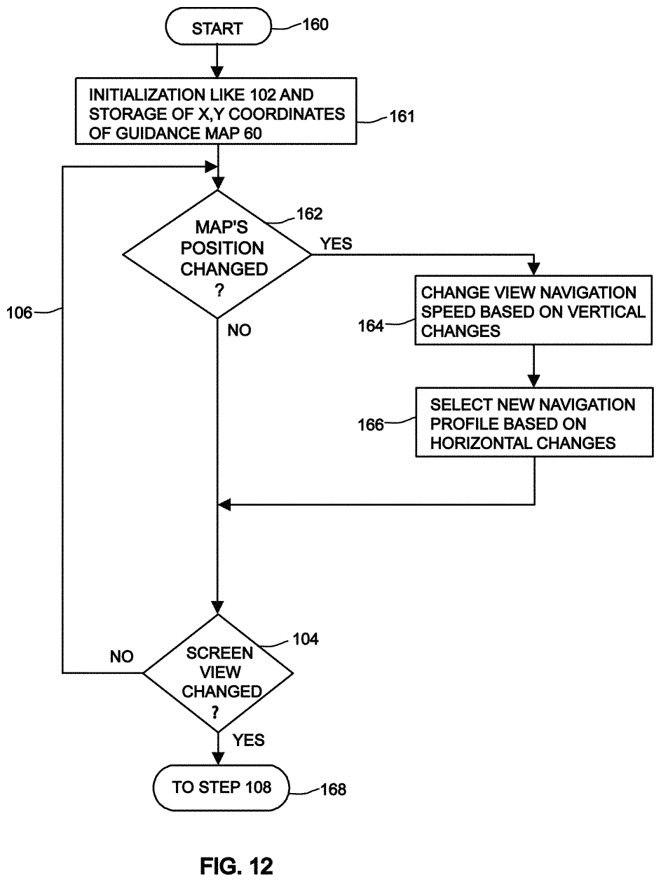

FIG. 12 outlines the software flow diagram of the embodiment of FIG. 11. The entire process is added to the overall operation of software flow diagram of FIG. 8, with same numerals assigned to corresponding steps. This process starts at step 160 (which is the same start step 100 of FIG. 8) and follows with an initialization step 161 that repeats the step 102 of FIG. 8 with the additional process of storing the initial x and y position coordinates of the guidance map 60 in the screen view. In step 162 the processor examines the current position coordinates x and y of the guidance map 60 and determines if the user has dragged the guidance map. Optional guidance map position changes due to step 112 of FIG. 8 (that are not dragged by the user) are ignored by step 162. If the guidance map was not dragged (or the changes are below a noise limit value), the process continues with steps 104, 106 and 108 of the software flow diagram of FIG. 8. If the guidance map was dragged, step 164 compares the vertical changes and uses the difference to compute a change in the view navigation speed. For example, if the vertical displacement Δy is positive (the monitor dragged up), then the speed of navigation is increased, and vice versa.

Step 166 further determines the horizontal displacement Δx, and use this value to select a different navigation profile. Such selection is made whenever Δx reaches discrete values. For example, if abs(Δx)<30 pixel width, no change is made. When it is between 80 and 30 pixels, profile 2 replaces profile 1, and when it is between −30 and −80 profile 3 replaces the current profile. For another example, dragging the guidance map 60 along the horizontal toward the center of screen view 42 may decrease its transparency (as it is more in the center of the view). In yet another example, dragging the guidance map towards the edge increases its transparency, thus making it more visible. Many other arrangements can be used to associate the guidance map's displacement along predefined paths with various parameter selections. It should be noted that for a one hand operation, dragging of the guidance map 60 can be easily made by the user's thumb.

FIG. 1 gave an example of a two-dimensional virtual display. The virtual display may contain three-dimensional objects like a 360° panoramic image, a 360° video and other types of 360° media contents. We use the term 360° virtual display in this application and the accompanying claims to refer to all types of 360° media contents, where view navigation is made by changing the virtual viewing direction and the magnification level (i.e. zoom-in, zoom-out). FIG. 13 shows a virtual display 230 of a 360° panoramic image. This 360° virtual display illustrates a hill that has two groups of trees and a range of snowy mountains in the horizon. There are three arbitrary screen view areas that are used to demonstrate the scrolling operation in several embodiments of the present invention. Screen view area 232 combines a tree and part of the mountain range. Screen view area 234 shows the nearby hill and another tree. Screen view area 236 is a zoom in into the mountain range in the horizon.

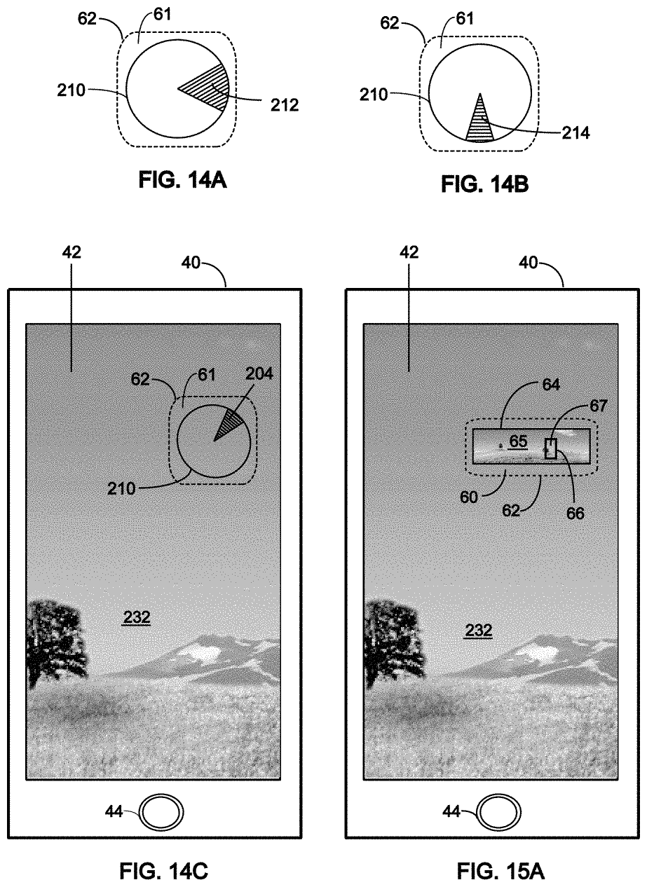

FIG. 14A and FIG. 14B illustrate directional guidance maps 61 that can be placed on a HUD layer like the guidance map of FIG. 4A and FIG. 4B. The directional guidance maps 61 comprising a predefined small transparent view area 62 which is composed on a top layer of the screen view in a heads-up display (HUD) fashion. They utilize a circular shape directional frame 210, where the sector frames 212 and 214 represent the angular width and the direction of the screen view. If the directional guidance maps 61 align the top of the circle with the North direction, then FIG. 14A indicates that the screen view is facing East at a low magnification, while FIG. 14B indicates that the screen view is facing the South direction at a higher zoom-in level. FIG. 14C illustrates the directional guidance map 61 in some embodiments of the present invention showing area 232 of the sample virtual display of FIG. 13 in the screen view 42 of the device 40. Assuming that the middle of the virtual display 230 of FIG. 13 is the North direction, sector 204 points to the North-East direction. The relative width of sector 204 reflects the ratio of the width of area 232 to the overall width of the 360° virtual display 230.

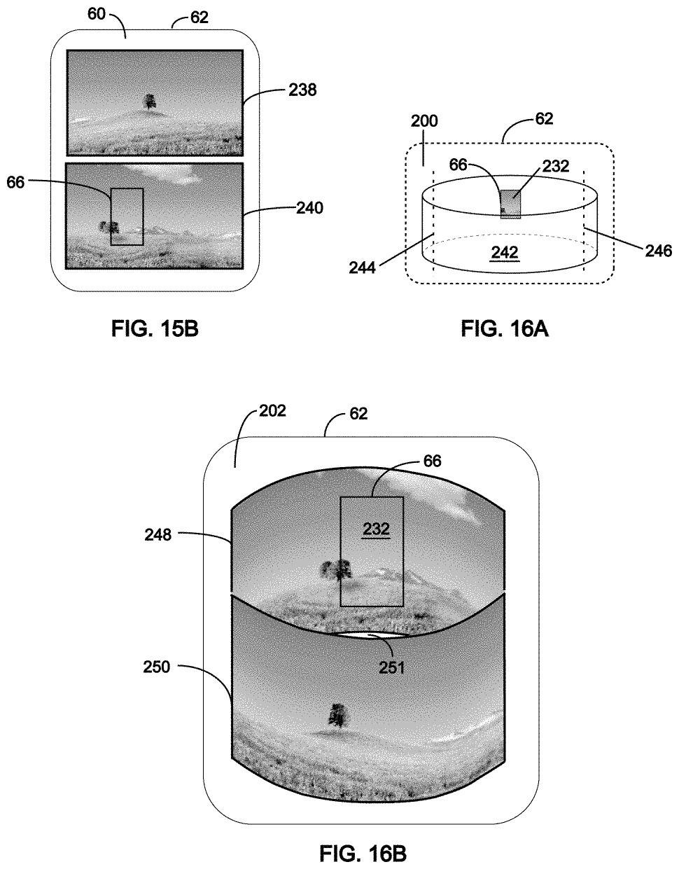

FIG. 15A illustrates the use of a context-based guidance map 60 for the same screen view of FIG. 14C. This context-based guidance map is similar to the one used in FIG. 3C and FIG. 4C. The graphic representation 65 in the virtual display frame 64 provides both vertical and horizontal context information for the screen view 66 position within the virtual display. Comparing the context-based guidance map 60 of FIG. 15A to the directional guidance map 61 of FIG. 14C, one can see in FIG. 15A that scrolling up will reach the clouds, while the directional guidance map 61 of FIG. 14C lacks any information regarding the vertical scrolling direction. In some embodiments of the present invention, it might be beneficial to partition the virtual display frame 64 of the context-based guidance map into two parts as shown in FIG. 15B. The top virtual display frame 238 shows the first half of the 360° panoramic image, while the bottom virtual display frame 240 shows the second half of the panoramic image. As the screen view scrolls the top frame 238 clockwise from left to right and reaches the right side of frame 238, the screen view continues at the left side of the bottom frame 240. Continuing scrolling clockwise beyond the right edge of the bottom frame 240 returns to the top frame 238 via its left edge.

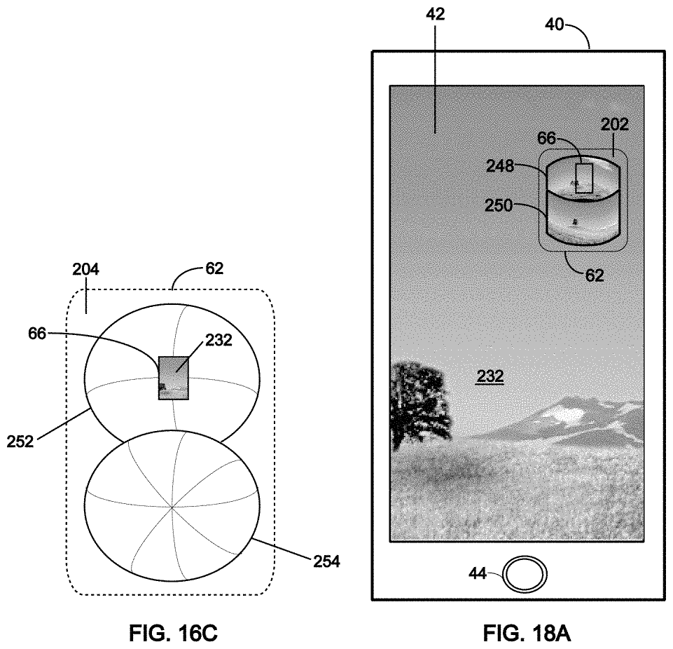

It may be intuitive to project the 360° panoramic image 230 on a cylinder surface 242 so that the current screen view 232 is projected at the center of the front side of the cylinder as shown in FIG. 16A. In such a cylindrical guidance map 200, it is assumed that the user “stands” at the center of the cylinder. Scrolling left or right rotates the projection on the cylinder surface 242 so that the screen view frame 66 always stays in front of the user. Scrolling in the vertical direction moves the screen view frame up or down on the cylinder surface. As a result, the cylindrical guidance map provides the proper immersive user experience. However, one disadvantage of this arrangement is that scrolling the screen view 66 all the way down causes the front surface of the cylinder to cover part of the screen view. This is why FIG. 16A does not show the actual graphic representation of the virtual display all around the cylinder. It shows only the projection of the screen view area 232. Another disadvantage of the cylindrical guidance map 200 is that the portions of the 360° panoramic virtual image 230 that are projected on the left of line 244 and to the right of line 246 tend to shrink or “disappear”. This disadvantage does not occur with the guidance map 60 of FIG. 15B as the full contents of the virtual display are depicted in frames 238 and 240.

FIG. 16B illustrates a modified cylindrical guidance map 202 that overcomes the above disadvantages in some embodiments of the present invention. The 360° panoramic virtual image 230 is first divided into two 180° sections so that the current position of the screen view 66 always appears at the center of the first 180° section. As a result, the first section provides the 180° front view of the virtual image and the second section provides the 180° back view. The side edges of the 180° front view overlaps the corresponding side edges of the 180° back view. The first section is then projected onto a first “flattened” half cylinder surface 248, and the second section is projected onto a second “flattened” half cylinder surface 250. The projection operation onto the half cylinder surfaces creates, of course, a two-dimensional (flat) representation of the 180° sections that can be rendered on the flat physical display. The first surface 248 represents the 180° front view, and the current screen view 66 is placed at the horizontal center of the surface. We will refer in this application and the accompanying claims to the first surface 248 as a substantially concave surface (i.e. the inner surface of the half cylinder or the half sphere). Similarly, we will refer to the second surface 250 as a substantially convex surface (i.e. the outer surface of the half cylinder or the half sphere). The second surface 250 represents the 180° back view and it may be placed at a lower vertical position than the front view, leaving a small open area 251 between the two surfaces. Alternatively, the second surface 250 may be placed above the first surface 248, causing the overall height of the combined two surfaces to be larger than the previous arrangement. Comparing FIG. 16B and FIG. 16A illustrates that the back view in frame 250 does not obstruct the front view in frame 248 and that the flattened cylindrical projection does not shrink the image on the sides of the frames. As the user changes the horizontal viewing direction (i.e. rotates the screen view), any part of the virtual display at the edge of the front view on surface 248 smoothly transfers to the corresponding overlapping edge of the back view on surface 250 and vice versa.

A typical 360° virtual display 230 provides more contents along the horizontal direction compared to the contents along the vertical direction. More particularly, such a virtual display does not allow 360° scrolling along the vertical direction. Therefore, 360° virtual displays can be easily projected onto the flattened half cylinder frames 248 and 250 of FIG. 16B. In some embodiments of the present invention there is a need to navigate the view of true spherical media, where full 360° scrolling along the vertical direction is possible. It should be noted that any true spherical image may be projected onto a cylinder, but the image may become distorted around the “North” and the “South” poles of the image. Many applications require fully detailed spherical navigation, as it is often true in virtual reality applications.

FIG. 16C discloses a spherical guidance map 204 where the front 180° view is projected onto the back of a first half spherical surface 252, and the back 180° view is projected onto the front of a second half spherical surface 254. We note again that surface 252 may be referred to as a substantially concave surface while surface 254 may be referred to as a substantially convex surface. The circular edge of the 180° front view overlaps the circular edge of the 180° back view. Similar to the modified cylindrical guidance map 202 of FIG. 16B, the screen view frame 66 is projected at the center of the first half spherical surface 252. As the user scrolls the screen view at any direction, any part of the virtual display at the edge of the front view on surface 252 smoothly transfers to the corresponding edge of the back view on surface 254 and vice versa. The half spherical surfaces 252 and 254 may be flattened to eliminate the shrinking of image data around the edge area, as discussed in conjunction with the frames 248 and 250 of the modified cylindrical guidance map 202 of FIG. 16B. The horizontal dimension of the spherical surfaces may be different (typically larger) than the vertical dimension as illustrated in FIG. 16C.

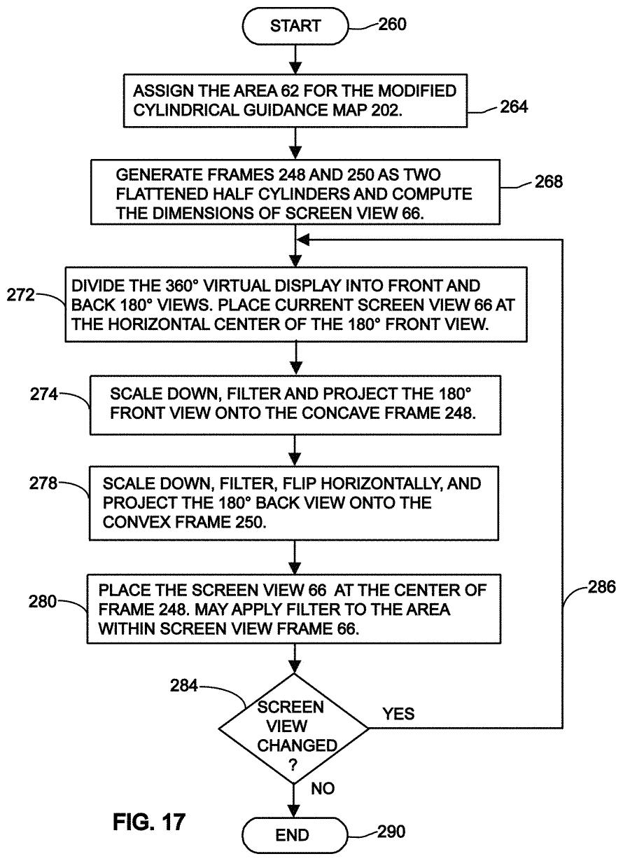

FIG. 17 outlines the software flow diagram of some embodiments of the present invention that renders the modified cylindrical guidance map 202 of FIG. 16B. The process that starts at step 260 may replace the rendering process performed by steps 104, 108 and 110 of FIG. 8. Step 264 assigns the HUD area 62 on which the modified cylindrical guidance map 202 is rendered. Like step 112 of FIG. 8, step 264 may optionally move the location of the modified cylindrical guidance map dynamically for optimal viewing of both the map and the actual screen view. Step 268 generates the frames 248 and 250 which are arranged as two flattened half cylinders placed back to back with a vertical displacement, as illustrated in FIG. 16B, so that the projection of the graphic representation of the back view on frame 250 will not obstruct the contents of the front view frame 248. The vertical displacement between the two frames may be changed dynamically based on the size and placement of the screen view frame 66. The width of the frames 248 and 250 are equal and made to fit the assigned area 62 for the modified cylindrical guidance map. The height of both frames is set to cover the height of the 360° panoramic virtual image 230 once it is scaled down for the width of the frames 248 and 250. Step 268 also computes the scaled down dimensions of the screen view frame 66 so that it will contain the current screen view 232.

As the modified cylindrical guidance map assumes that the user is “standing” at the center of the cylindrical projection, and in order to provide complete context-based view navigation guidance, the current screen view frame 66 is placed at the horizontal center of frame 248. Therefore, step 272 divides the 360° panoramic virtual image 230 into two 180° views, the front context view and the back context view, so that the current position of the screen view 66 appears at the horizontal center of the 180° front view. Step 274 scales down the 180° front view so that it can be projected onto the concave surface of frame 248. A graphic filter, like the monochromatic filter described for the context-based guidance map of FIG. 4C, may be applied to the front image. Similarly, step 278 performs the same scaling to the 180° back view so that it can be projected onto the convex surface of frame 250. Notice that step 278 flips the back 180° image horizontally (i.e. reflection around the vertical axis) so that the left and right sides of both projections on frames 248 and 250 coincide correctly. The same or different filter of step 274 may be applied to the back 180° image. Step 280 places the scaled down screen view frame 66 that was computed in step 268 at the correct vertical location at the horizontal center of frame 248. The inside of the screen view frame 66 may be totally transparent so it shows the current viewing area from the projected 180′ front view as processed and filtered in step 274. In some embodiments of the present invention, the viewing area 232 inside the screen view 66 may be processed by a different filter at step 280 to further distinguish between the screen view area and the surrounding virtual display projection on frame 248. For example, the projections on frames 248 and 250 may be monochromatic, while the viewing area inside the screen view frame 66 may be rendered in full color or in a different monochromatic color.

As the user continues to scroll or to change the zoom level of the screen view, decision step 284 repeats the guidance map rendering process of steps 272, 274, 278, and 280 via flow 286. Step 290 ends the process of FIG. 17 when step 284 determines that the screen view stops changing. As discussed in conjunction with FIG. 8, step 290 may signal the processor 80 to turn off the modified cylindrical guidance map 202. The software flow diagram of FIG. 17 is also applicable for the spherical guidance map 204 of FIG. 16C, where frames 248 and 250 are replaced with spherical surfaces 252 and 254, respectively.

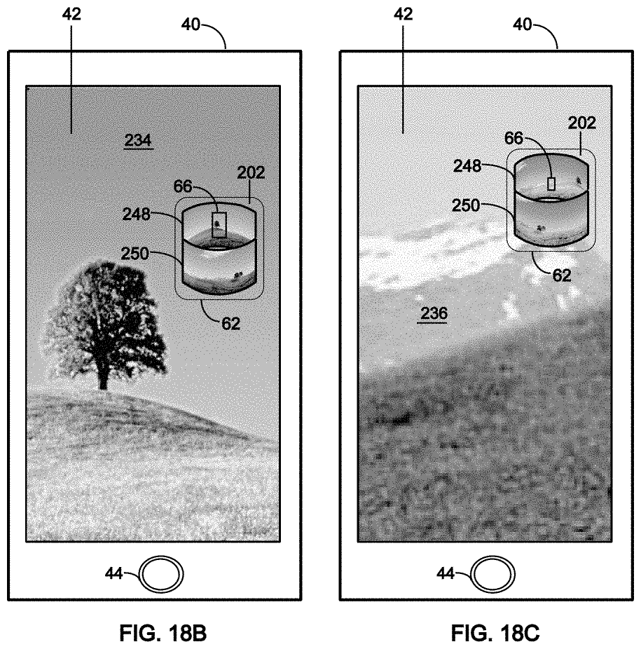

FIGS. 18A, 18B and 18C include three examples illustrating how the 360° panoramic virtual image 230 is scrolled and zoomed in with the modified cylindrical guidance map 202. FIG. 18A illustrates the system when the screen view is showing area 232 of FIG. 13. The modified cylindrical guidance map 202 is placed by the user (or optionally by step 264 of FIG. 17) at the top right corner of the screen view 42 of the device 40. The user scrolls to the right side and also slightly magnifies the view, to reach area 234 of FIG. 13. As the scrolling continues, the projections along the frames 248 and 250 smoothly rotate at the opposite direction, to keep the screen view frame 66 at the horizontal center of frame 248. FIG. 18B shows that the modified cylindrical guidance map 202 has been arbitrarily moved over the screen view 42 by the user. Of course, the guidance map 202 may stay at the same position as shown in FIG. 18C. Here the user has zoomed in significantly to view detailed area 236 of the snowy mountain in the horizon of the 360° panoramic virtual image 230.

FIGS. 18A, 18B and 18C demonstrate that the modified cylindrical guidance map provides continuous context-based guidance when navigating the small screen of a smart phone device 40. It should be well understood to a person skilled in the art that this modified cylindrical guidance map can be used successfully in desktop displays, where the screen view and guidance map may be placed in separate windows.

The foregoing example of the 360° virtual display 230 of FIGS. 13-18 demonstrates a three-dimensional world that is viewed from the center to all directions around the center. Another common three-dimensional viewer is the three-dimensional model viewer, where a virtual model of a three-dimensional object is viewed from the outside around a center point assigned within the three-dimensional model. The virtual model may be stationary (e.g. a fixed three-dimensional object) or it may be a changing virtual model representation (e.g. a video animation media). The three-dimensional model viewer typically assigns a center point within the virtual model and the viewing is done by rendering a screen view showing the virtual model from a virtual viewing direction and from a virtual viewing distance to the center point. Changing the virtual viewing direction causes the virtual model to rotate in the screen view. Changing the virtual viewing distance causes the view to zoom in and zoom out, that is, modifying the magnification. As the virtual viewing distance becomes very small, the screen view may show a view captured from the internal structure of the virtual model. In some three-dimensional model viewers, the user may select a negative virtual viewing distance to the center point, causing the screen view to pass through the entire virtual model and even show what lies beyond the model.

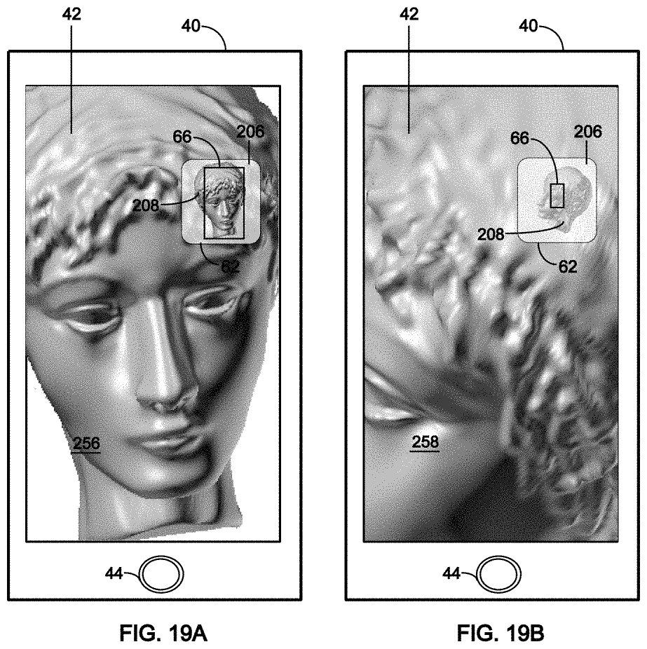

FIGS. 19A and 19B demonstrate another embodiment of the present invention with a three-dimensional virtual model viewer, where a three-dimensional virtual model of a sculpture of the head of a Greek goddess is viewed using the context-based three-dimensional guidance map 206. The processor of the device 40 manipulates a three-dimensional virtual representation of the head in the memory with its assigned center point of the model. During the view navigation of the virtual model, the user changes the virtual viewing direction and the virtual viewing distance to the center point, and the processor renders the view of the virtual model as “seen” from these virtual viewing direction and virtual viewing distance on the device's screen view 42. FIG. 19A illustrates the screen view area 256 which shows the head from the front virtual viewing direction with a virtual viewing distance providing a small magnification. FIG. 19B illustrates the screen view area 258 which shows the head from a different virtual viewing direction with a higher magnification due to a shorter virtual viewing distance.

A scaled down full image of the virtual model 208 is rendered on the HUD layer 62 of the three-dimensional guidance map 206, as the object 208 is viewed from the currently selected virtual viewing direction. The current screen view 42 is presented by the substantially transparent frame 66 that encompasses the contents of the model 208 that are currently viewed on the screen view. The frame 66 remains at the center of the guidance map as it must have the assigned center point of the virtual model in its center. As the user navigates the virtual model from FIG. 19A to FIG. 19B, the virtual viewing direction is changed so that the virtual model of the head is now viewed from the side, and the virtual viewing distance to the center point is decreased to provide the magnification seen in screen view area 258. The guidance map 206 rotates the object 208 so that it is viewed from the same virtual viewing direction, and the size of screen view frame 66 is reduced to provide the proper context-based guidance. Various graphic filters may be applied to the object 208 as well as to the screen view frame 66 in order to achieve the desired level of contrast between the entire model 208 and the contents within the screen view frame 66, as described above in conjunction with the other embodiments of context-based guidance maps of the present invention. Similarly, the color selection of the screen view frame 66 may change dynamically, based on the color of the contents of the model 208 under the frame. In some embodiments, the position of the guidance map 206 over the screen view 42 may be changed dynamically by the processor to place it in an area of the screen view with minimal contents.

In some embodiments with touch displays, the user may drag the screen view 42 to rotate the virtual model. The virtual viewing distance to the center point of the virtual model, may be controlled by the standard pinch hand gesture. The color of the frame 66 may be changed dynamically when the virtual viewing distance becomes so small that the screen view shows internal contents of the virtual model. It may still change to another color if the user selects a negative virtual viewing distance to look beyond the virtual model. In other embodiments in a mobile device 40, the device actual rotation may be used to change the virtual viewing direction to the model center point. In desktop application, similar viewing control commands can be made by the mouse and/or the keyboard. The mouse scrolling wheel may be used to select the virtual viewing distance.

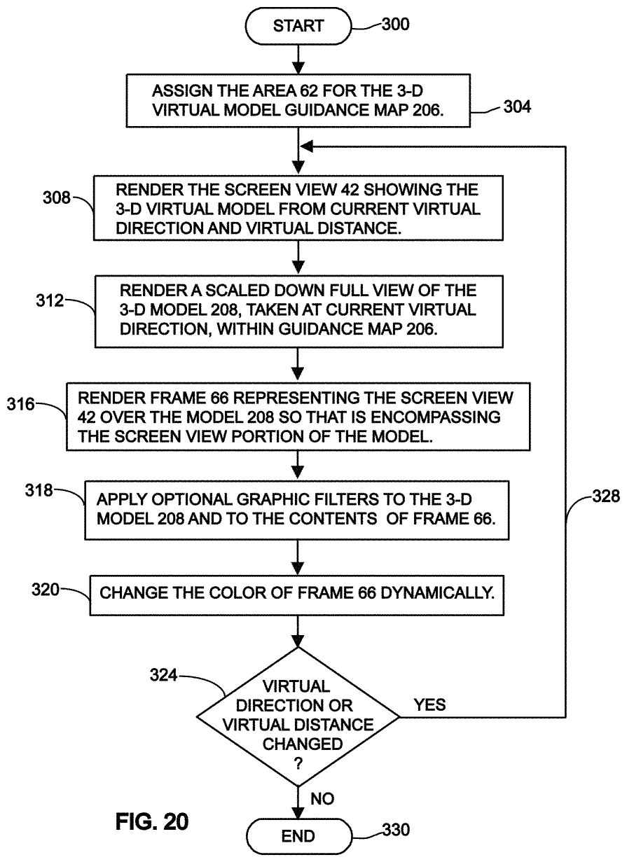

FIG. 20 outlines the software flow diagram for rendering the three-dimensional virtual model viewer of FIGS. 19A and 19B with the context-based view navigation guidance map 206 of some embodiments of the present invention. The process flow, starting at step 300 and ending at step 330, is performed continuously while the three-dimensional virtual model is navigated. At step 300, the three-dimensional model is already loaded onto the memory in a representation that has the model center point and the current virtual viewing direction and current virtual viewing distance. Step 304 assigns the position and the HUD area 62 of the guidance map 206. This may be fixed by the user preference (e.g. at the top right location as shown in FIGS. 19A and 19B), or it may be changed dynamically, based on the current contents of the screen view 42, to place the map at the screen view area where it may cause the least obstruction. Step 308 performs the rendering of the screen view based on the current virtual viewing direction and the current virtual viewing distance from the assigned model's center point. In step 312, a scaled down model 208 of the virtual model taken at the current virtual viewing direction is rendered in the guidance map 206, so that the model 208 fits the area 62 and its center point is placed at the center of the guidance map. A frame 66, representing the shape of the screen view 42 (e.g. a rectangle) and encompassing the current contents shown in the screen view, is proportionally rendered in step 316 at the center of the guidance map 206 over the model 208.

Step 318 may apply optional graphic filters to the model 208 and to the contents of the frame 66 to achieve a desired contrasting effect. For example, model 208 may be filtered monochromatically to show a black white rendition, while the contents in frame 66 may be left at true colors. The color of the frame 66 may be dynamically changed in step 320 to indicate whether the screen view shows the outside view of the virtual model or, if the virtual viewing distance is set smaller, whether the screen view shows an inside view of the virtual model. Similarly, another frame color may indicate that the virtual viewing distance is negative and the screen view shows what is beyond the virtual model. The color of the frame 66 may change dynamically to provide a desired contrast to the model 208 based on the colors of the model 208 just beneath the frame 66, as discussed in much detail above. The process of steps 308, 312, 316, 318 and 320 repeats along path 328 if the decision step 324 detects changes in the virtual viewing direction and/or the virtual viewing distance.

Some embodiments of the present invention may include tangible and/or non-transitory computer-readable storage media for storing computer-executable instructions or data structures. Such non-transitory computer-readable storage media can be any available media that can be accessed by a general purpose or special purpose computer, including the processors discussed above. By way of example, and not limitation, such non-transitory computer-readable media can include RAM, ROM, EEPROM, or any other medium which can be used to carry or store desired program code means in the form of computer-executable instructions. Computer-readable medium may be also manifested by information that is being transferred or provided over a network or another communications connection to a processor. All combinations of the above should also be included within the scope of the computer-readable media.

Computer-executable instructions include instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, abstract data types, and the functions inherent in the design of special-purpose processors, etc. that perform particular tasks. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments described above may make reference to specific hardware and software components. It should be appreciated by those skilled in the art that particular operations described as being implemented in hardware might also be implemented in software or vice versa. It should also be understood by those skilled in the art that different combinations of hardware and/or software components may also be implemented within the scope of the present invention.

The description above contains many specifications, and for purpose of illustration, has been described with references to specific embodiments. However, the foregoing embodiments are not intended to be exhaustive or to limit the invention to the precise forms disclosed. Therefore, these illustrative discussions should not be construed as limiting the scope of the invention but as merely providing embodiments that better explain the principle of the invention and its practical applications, so that a person skilled in the art can best utilize the invention with various modifications as required for a particular use. It is therefore intended that the following appended claims be interpreted as including all such modifications, alterations, permutations, and equivalents as they fall within the true spirit and scope of the present invention.

I claim:

1. A computer-implemented method for context-based view navigation of a virtual display on the screen view of a physical display, the method comprising:
generating a first graphical object representing said virtual display;
generating a second graphical object representing said screen view having a frame corresponding to the shape of said screen view;
rendering a guidance map on a graphic layer showing said second graphical object over said first graphical object, wherein said second graphical object encompasses the area of said first graphical object that represents the portion of said virtual display shown on said screen view;
displaying said graphic layer with said guidance map as a heads-up display layer on said screen view;
detecting changes in the relation between said screen view and said virtual display; and
updating said guidance map in response to said detected changes to reflect the position and size of said screen view relative to said virtual display.

2. The computer-implemented method of claim 1, wherein said second graphical object shows a scaled down image of said screen view.

3. The computer-implemented method of claim 2, further comprising applying a graphic filter to said scaled down image of said screen view.

4. The computer-implemented method of claim 1, wherein said first graphical object having a frame corresponding to the shape and size of said virtual display.

5. The computer-implemented method of claim 4, wherein said first graphical object shows a scaled down full image of said virtual display.

6. The computer-implemented method of claim 5, further comprising applying a graphic filter to said image of said virtual display.

7. The computer-implemented method of claim 1, wherein said virtual display is a three-dimensional virtual model that is captured on said screen view from a user selected virtual viewing direction and a user selected virtual viewing distance, and wherein said first graphical object comprising a scale down full image of said virtual model taken at said user selected virtual viewing direction.

8. A computer-implemented method for context-based view navigation of a 360° virtual display by the screen view of a physical display, the method comprising:
dividing said 360° virtual display into two contiguous sections wherein the first section is the 180° front view of said virtual display and the second section is the 180° back view of said virtual display so that said screen view displays the contents at the horizontal center of said 180° front view section;
generating a first graphical object representing said 180° front view section;
generating a second graphical object representing said 180° back view section;
generating a third graphical object representing said screen view having a frame corresponding to the shape of said screen view;
rendering a guidance map on said physical display comprising said first and second graphical objects whereby one of said first and second graphical object is placed substantially above the other along the vertical direction of said physical display;
adding said third graphical object to said guidance map over the horizontal center of said first graphical object so that said third graphical object encompasses the contents of said 180° front view section that are displayed on said screen view;
detecting changes in the virtual viewing direction and the view magnification; and
updating said guidance map in response to said detected changes.

9. The computer-implemented method of claim 8, further displaying a graphic layer with said guidance map as a heads-up display layer over a portion of said screen view.

10. The computer-implemented method of claim 8, wherein said first graphical object is a projection of the contents of said 180° front view section on a substantially concave surface, and wherein said second graphical object is a projection of the contents of said 180° back view section on a substantially convex surface.

11. The computer-implemented method of claim 10, wherein said substantially concave surface resembles the inner surface of a half cylinder, and wherein said substantially convex surface resembles the outer surface of a half cylinder.

12. The computer-implemented method of claim 10, wherein said substantially concave surface resembles the inner surface of a half sphere, and wherein said substantially convex surface resembles the outer surface of a half sphere.

13. The computer-implemented method of claim 10, wherein said concave surface and said convex surface are flattened to minimize the shrinkage of the projected contents of said virtual display near the overlapping edges of said surfaces.

14. The computer-implemented method of claim 8, wherein said first graphical object is rendered vertically above said second graphical object.

15. The computer-implemented method of claim 8, further comprising updating said guidance map when said contents of said 360° virtual display change.

16. A view navigation guidance system for three-dimensional virtual models comprising:
one or more processors;
a display coupled to said one or more processors;
a storage device coupled to said one or more processors for storing executable code to interface with said display, the executable code comprising:
code for representing and rendering a three-dimensional virtual model on said display;
code for navigating the screen view of said display over said virtual model by changing the virtual viewing direction and the virtual viewing distance;
code for rendering a guidance map on a graphical layer, said guidance map comprising a first view and a second view, said first view is a full image of said virtual model taken at said virtual viewing direction, said second view is having a frame corresponding to the shape of said screen view and is placed over said first view so that it encompasses the portion of the contents of said first view that are shown by said screen view;
code for displaying said graphic layer with said guidance map as a heads-up display layer on said screen view;
code for detecting changes in said virtual viewing direction and said virtual viewing distance; and
code for updating said guidance map in response to said detected changes.

17. The view navigation guidance system of claim 16, wherein the executable code further comprising a code for applying a graphic filter to said first view.

18. The view navigation guidance system of claim 16, wherein said second view is a frame with a transparent interior showing the contents of said first view under said frame.

19. The view navigation guidance system of claim 18, wherein the executable code further comprising a code for dynamically selecting the color of said frame.

20. The view navigation guidance system of claim 18, wherein the executable code further comprising a code for applying a graphic filter to said contents of said first view under said frame.

21. The view navigation guidance system of claim 16, wherein the executable code further comprising a code for dynamically changing the location of said guidance map over said screen view.
